(19) United States
(12) Patent Application Publication
(10) Pub. No.: US 2015/0306674 A1
(43) Pub. Date: Oct. 29, 2015

(54) STRUCTURE-IMPROVED CLAMPING CHUCK

(71) Applicant: WE CHEER INDUSTRIAL CO., LTD., TAICHUNG CITY (TW)

(72) Inventor: SHU-WEN HSIAO, TAICHUNG CITY (TW)

(73) Assignee: WE CHEER INDUSTRIAL CO., LTD., TAICHUNG CITY (TW)

(21) Appl. No.: 14/261,779

(22) Filed: Apr. 25, 2014

(51) Int. Cl. B23B 31/00; B23B 31/173

(52) U.S. Cl. CPC B23B 31/003; B23B 31/16158

(57) ABSTRACT

The invention relates to a structure-improved clamping chuck, which is mainly a sleeve provided for placing a clamp inside, a base is fastened on its rear end, and a through hole is set on its front end for a tool piece passing through, the clamp includes four jaws arranged in a ring, elastic elements are set in between two adjacent jaws, two limit ends are formed respectively between two inner sides of each jaw, one end of a drive rod is screwed in the sleeve, the drive rod is driven by electric (air) power, a roller tray is slipped on an upper end of the drive rod, an ejecting block is set on the roller tray, the ejecting block is set below the clamp. The ejecting block is pushed or left the clamp by rotating the drive rod, to clamp or departing from release a tool piece.

### BACKGROUND OF THE INVENTION

(a) Field of the Invention

The invention relates to a structure-improved clamping chuck and, more particularly, a clamping chuck driven by electric (air) power to rotate for acting on work pieces, the clamping chuck is consisted of a sleeve, a clamp, a base, an ejecting block, a drive rod and a roller tray, the sleeve is provided for placing the clamp inside, a base is fastened on its rear end, and a through hole is set on its front end for a tool piece passing through, the clamp includes four jaws arranged in a ring, elastic elements are set in between two adjacent jaws, limit ends are formed between walls on two inner sides of the jaws, one end of a drive rod is screwed in the sleeve, a roller tray is slipped on an upper end of the drive rod, an ejecting block is set on the roller tray, the drive rod is driven by electric (air) power, the ejecting block is set below the clamp. The ejecting block is pushed or left the clamp by rotating the drive rod, to clamp or release a tool piece. Friction between the drive rod and the ejecting block may be reduced by installation of the roller tray, to achieve the purpose of rotating smoother, quicker and saving effort and extending service life of the clamping chuck. Besides, the purpose of accurately and stably clamping the tool piece may be achieved by the design of limit ends of the jaws.

(b) Description of the Prior Art

Please refer to the attachment 1, which is the invention “structure-improved clamping chuck” with patent number 100206644 (hereinafter cited reference), its clamping chuck 10 is a sleeve 11 with a clamp 12 set in one end, jaws are triangle-columnar shape, elastic elements 12 are set in between two adjacent jaws, a bulge is formed on inner sides of the jaws, a base 13 is screwed in rear of the sleeve 11, an ejecting block 14 is set on the base 13, a shaft hole is set on the ejecting block 14, a shaft hole is also set on the base 13 for a drive rod 15 passing through and fastening with the sleeve 11. As such structure, the drive rod 15 is driven to perform a pushing or a leaving action by rotating the sleeve 11, so that the ejecting block 14 pushes or leaves the clamp 12 to let the clamp 12 be tightly fit or released, to thereby achieve the purpose of clamping or releasing a tool piece 16. It is described that structure and action of the conventional clamping chuck 10 (as shown in FIG. 1 in the cited reference), the drawbacks of the structure are as follow:

1. In the conventional clamping chuck, the drive rod is driven to perform a pushing or a leaving action by rotating the sleeve, the ejecting block pushes or leaves the clamp to let the clamp 12 be tightly fit or released, so an end side of the drive rod is tightly attached on an end side of the ejecting block, thus the friction area is large and a larger friction is formed when rotating the sleeve, it needs more effort for fastening, the service life of the clamping chuck may also be affected;

2. When the conventional jaws are positioned to clamp, the tool piece is clamped by the bulges. The tool piece may easily be released from the jaws due to the vibration generated by high-speed rotation or the tool piece working on work pieces, and work progress and quality may thereby be affected; also, it is operational risk that the tool piece drops due to vibration.

### SUMMARY OF THE INVENTION

In view of drawbacks in structure of the above conventional one, the inventor researches continuously and invents a clamping chuck, wherein a roller tray is set between a drive rod and an ejecting block, several balls set on the roller tray are provided to reduce friction area of the drive rod and the ejecting block, so that rotating the drive rod may be smoother and saving more effort. The clamp is consisted of four jaws and eight limit ends are formed to strengthen contact points between the tool piece and the jaws, to achieve the purpose of improving clamping force and accuracy for the tool piece, to thereby effectively make the jaws and the tool piece tightly attached for preventing the tool piece sliding and loosing and improve quality.

As the above structure, the object of the present invention is to provide a clamping chuck structure for positioning tool pieces fast and effort-saving, which may strengthen positioning for tool pieces, reduce vibration during tool pieces acting and keep tool pieces in a better stability to improve quality.

### BRIEF DESCRIPTION OF THE DRAWINGS

FIG. 1 is a three-dimensional exploded view according to the present invention;

FIG. 2 is a three-dimensional diagram of the jaw according to the present invention;

FIG. 3 is a combination cross-sectional view according to the present invention;

FIG. 4 is a combination diagram of an end of the jaw according to the present invention;

FIG. 5 is an operation schematic diagram (1) according to the present invention;

FIG. 6 is an operation schematic diagram (2) according to the present invention; and

FIG. 7 is a partial enlarged schematic view of FIG. 6.

### DETAILED DESCRIPTION OF THE PREFERRED EMBODIMENTS

In order to let examiners further understand structural features and practical efficacy of the present invention, a preferred embodiment is described in details with diagrams as follow:

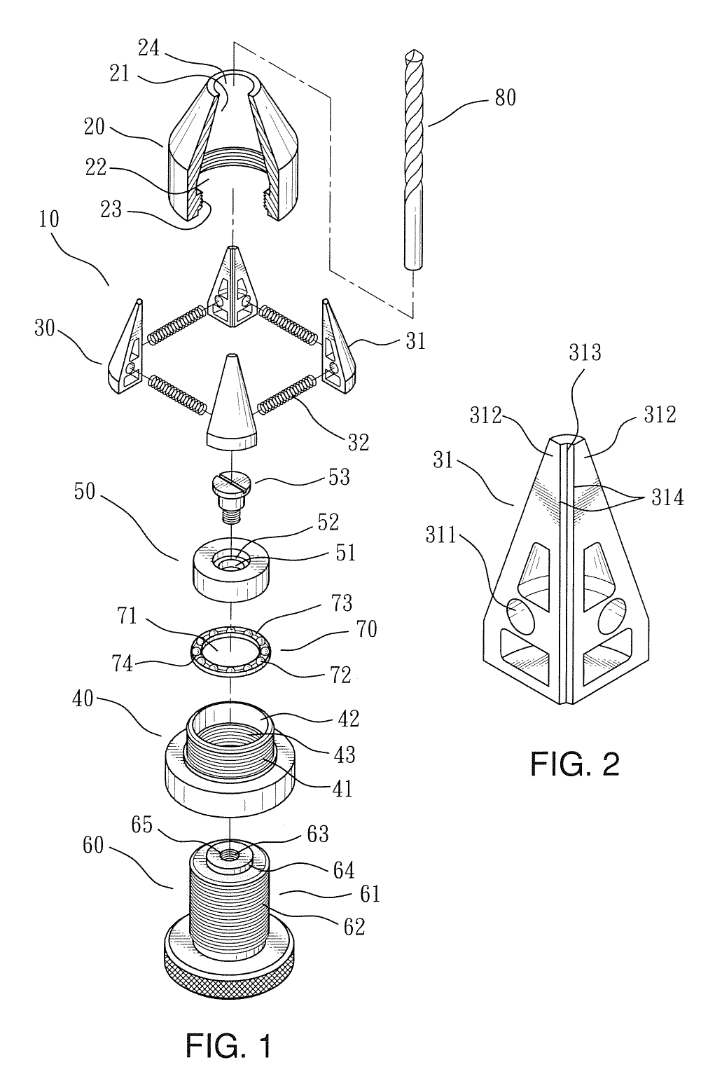

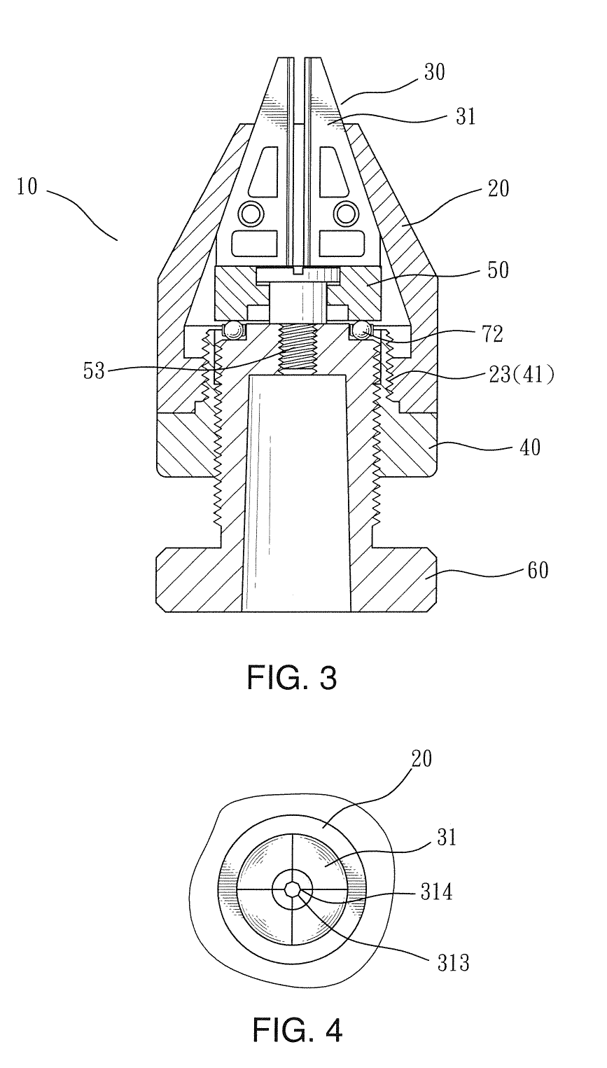

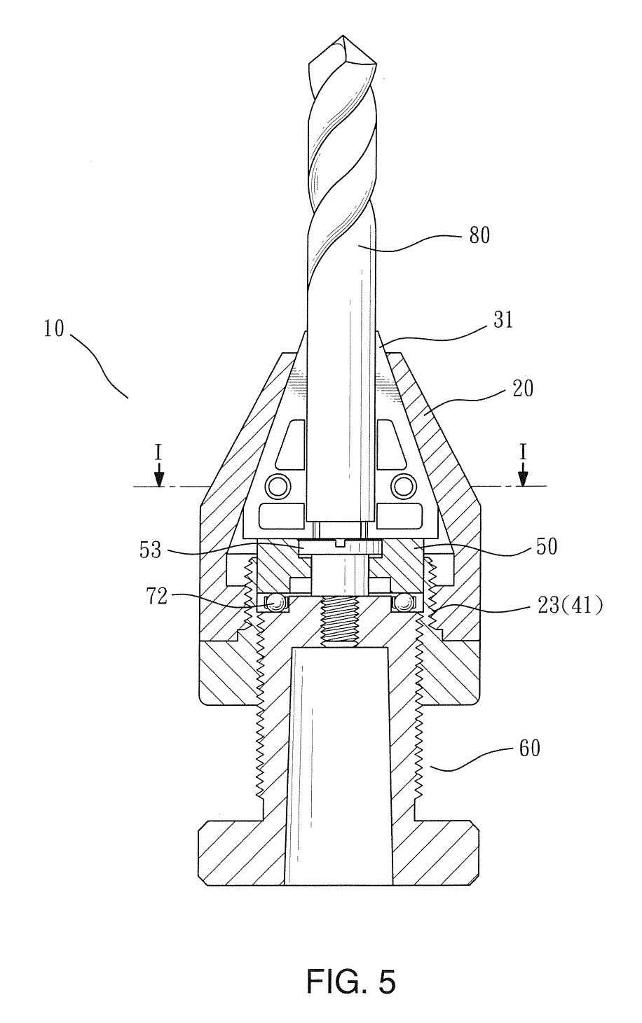

Please refer to FIG. 1 to FIG. 6, the clamping chuck 10 of the present invention is mainly consisted of a sleeve 20, a clamp 30, a base 40, an ejecting block 50, a drive rod 60 and a roller tray 70, wherein:

the sleeve 20, which is conical shape and provided for placing the clamp 30 inside, a necking part 21 is set on an inner side of its front end, a wide mouth part 22 is set in the rear section, an inner threaded section 23 is set in the rear section for the base 40 to fasten, and a through hole 24 is set on its front end for a tool piece 80 passing through;

the clamp 30, which is consisted of multiple jaws 31 arranged in a ring, the jaws 31 are triangle-columnar shape, elastic elements 32 are set in between two adjacent jaws 31, two concave holes 311 are respectively set on two inner sides of the jaw 31 for placing and limiting the elastic element 32, a bulge 312 is formed between two inner sides of the jaws, a groove is set on the bulge 312 and two limit ends 314 are thereby formed on the jaw 31;

the base 40, an outer threaded section 411 is set on its upper end for screwing in the rear of the sleeve 20, a shaft hole 42 is set on the base 40 for a drive rod 60 passing through, an inner threaded section 43 is set on the lower end of the base 40 for the drive rod 60 to screw;

the ejecting block 50, which is installed below the clamp 30 and above the drive rod 60, a shaft hole 51 and a cavity 52 are set on it for a set screw 53 to fasten with the drive rod 60;

the drive rod 60, a convex section 61 with an outer threaded section 62 is set on one end for screwing with the inner threaded section 43 of the base 40, a shaft hole 63 corresponding to the base 40 and the ejecting block 50 is set on the convex section 61, the drive rod 60 is driven by electric (air) power, a convex column 64 is set on its upper end for a roller tray 70 to slip on, an inner threaded section 65 is formed inside the convex column 64 for the set screw of the ejecting block 50 to screw;

the roller tray 70, which is an annular disk body with a hole 71 for slipping on the convex column 64 of the drive rod 60, multiple receiving holes 74 are set on the disk body for placing the same number of balls 72, a concave ring 73 is formed on another end for preventing the balls dropping.

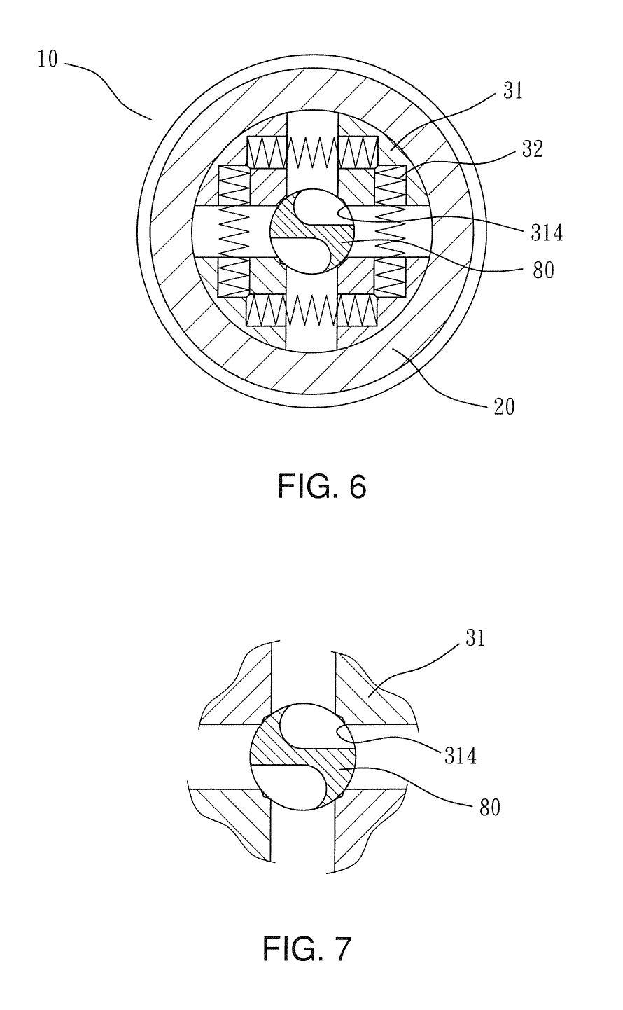

In such structure, the above ejecting block 50 pushes or leaves the clamp 30 if the drive rod 60 is rotated. When the drive rod 60 is screwed forwards, the ejecting block 50 pushes the necking part 21 of the sleeve 20 to let the jaws 31 of the clamp 30 be tightly attached and achieve the purpose of clamping a tool piece 80. By the roller tray 70 set between the drive rod 60 and the ejecting block 50, when pushing (fastening), the motion of pushing (fastening) becomes smoother with less friction due to the motion of the balls 72 on the roller tray 70. When friction is reduced, the rotation becomes smoother, effort-saving and quick, and service life of the clamping chuck may also be extended. Also, in the present invention, the jaws 31 clamp with the tool piece 80 by the approaching of two limit ends 314 of the jaws 31. Since the clamp 30 of the present invention is consisted of four jaws 31, position of eight limit ends 314 is formed to achieve the purpose of stably clamping and limiting the tool piece 80 inside the sleeve 20 easily (as shown in FIG. 6 and FIG. 7), so that the tool piece 80 may not easily be dropped when being driven to rotate by electric (air) power, it does not need to perform any adjustment.

Otherwise, when the drive rod 60 moves backwards, the ejecting block 50 leaves the clamp 30 and is not be contacted to the clamp 30, the clamp 30 moves towards the wide-mouth part 22. By elasticity of the elastic element 32 of the clamp 30, the space between the jaws 31 becomes larger to achieve the purpose of loosening the tool piece 80 for changing another one.

Besides, a set screw 53 is used to fasten the ejecting block 50 on the drive rod 60, and fastening mode of the set screw 53 and the drive rod 60 is clockwise screw-thread or counter-clockwise screw-thread mode.

What is claimed is:

1. A structure-improves clamping chuck, which is a clamping chuck consisted of a sleeve, a clamp, a base, an ejecting block, a drive rod and a roller tray, the sleeve is conical shape and provided for placing the clamp inside, a base is fastened on its rear end, and a through hole is set on its front end for a tool piece passing through, the clamp is consisted of several jaws of a triangle-columnar shape, elastic elements are set in between two adjacent jaws, a bulge is formed between walls on two inner sides of the jaws, the ejecting block moved by displacement of the drive rod is set on the base, the ejecting block is set below the clamp, an front end of the drive rod is screwed with an inner edge of the base, and the drive rod is driven by electric (air) power, wherein:
the clamp, which is consisted of four jaws arranged in a ring, a groove is set between two bulges of the jaw and two limit ends are formed on the jaw;
the ejecting block, a shaft hole is set on it for being screwed with the drive rod by a set screw;
the drive rod, a convex column is set on its upper end for a roller tray slipping on;
the roller tray, which is an annular disk body with a hole for slipping on the convex column of the drive rod, multiple receiving holes are set on the disk body for placing the same number of balls, a concave ring is formed on another end for preventing the balls dropping.

2. The structure-improves clamping chuck as claimed in claim 1, wherein:
the base, an outer threaded section is set on its upper end for screwing in the rear of the sleeve, a shaft hole is set on the base for a drive rod passing through, an inner threaded section is set on the lower end of the base for the drive rod to screw;
the drive rod, its convex section includes an outer threaded section for screwing with the inner threaded section of the base, a shaft hole corresponding to the base and the ejecting block is set on the convex section, an inner threaded section is formed inside the convex column for the set screw of the ejecting block to screw.

3. The structure-improves clamping chuck as claimed in claim 1, wherein fastening mode of the set screw and the drive rod is clockwise screw-thread or counter-clockwise screw-thread mode.
